(19) United States
(12) Patent Application Publication
(10) Pub. No.: US 2005/0116635 A1
(43) Pub. Date: Jun. 2, 2005

(54) Multiple LED source and method for assembling same

(76) Inventors: James E. Walson, Maplewood, MN (US); Anthony J. Nichol, Madison, WI (US)

Correspondence Address: 3M INNOVATIVE PROPERTIES COMPANY, PO BOX 33427, ST. PAUL, MN, 55133-3427, US

(21) Appl. No.: 10/726,248

(22) Filed: Dec. 2, 2003

(51) Int. Cl. H01J 9/00; H01J 9/24; H05B 33/04; H05B 33/00

(52) U.S. Cl. 313/512; 313/506; 445/24

(57) ABSTRACT

A light source is formed using a plurality of light emitting diodes (LEDs). A first layer of material, transparent to the light emitted by the LEDs, is placed over the plurality of LEDs. Light passes through the first layer of material from the LEDs to a phosphor layer disposed on the other side of the first layer. Light is converted in the phosphor to produce broadband, white light. The first layer of material may be reflective at the wavelength of the converted light, so that converted light propagating back towards the LEDs is reflected into the forward direction. The phosphor material may be formed as patches on the first layer. An array of couplers, such as reflective couplers, may be used to couple the wavelength converted light produced by each LED into respective optical fibers.

### RELATED PATENT APPLICATIONS

The following co-owned and concurrently filed U.S. patent applications are incorporated herein by reference: “ILLUMINATION SYSTEM USING A PLURALITY OF LIGHT SOURCES”, having Attorney Docket No. 58130US004; “REFLECTIVE LIGHT COUPLER”, having Attorney Docket No. 59121US002. “SOLID STATE LIGHT DEVICE”, having Attorney Docket No. 59349US002; “ILLUMINATION ASSEMBLY”, having Attorney Docket No. 59333US002; “PHOSPHOR BASED LIGHT SOURCES HAVING A POLYMERIC LONG PASS REFLECTOR”, having Attorney Docket No. 58389US004; and “PHOSPHOR BASED LIGHT SOURCES HAVING A NON-PLANAR LONG PASS REFLECTOR”, having Attorney Docket No. 59416US002.

### FIELD OF THE INVENTION

The invention relates to optical systems and is more particularly applicable to illumination systems based on the use of multiple light sources.

### BACKGROUND

Illumination systems are used in many different applications. Home, medical, dental, and industrial applications often require light to be made available. Similarly, aircraft, marine, and automotive applications require high-intensity illumination beams. Traditional lighting systems have used electrically powered filament or arc lamps, which sometimes include focusing lenses and/or reflective surfaces to direct the produced illumination into a beam. However, in certain applications, such as in swimming pool lighting, the final light output may be required to be placed in environments in which electrical contacts are undesirable. In other applications, such as automobile headlights, there exists a desire to move the light source from exposed, damage-prone positions to more secure locations. Additionally, in yet other applications, limitations in physical space, accessibility, or design considerations may require that the light source be placed in a location different from where the final illumination is required.

In response to some of these needs, illumination systems have been developed using optical waveguides to guide the light from a light source to a desired illumination point. One current approach is to use either a bright single light source or a cluster of light sources grouped closely together to form a single illumination source. The light emitted by such a source is directed with the aide of concentrating optics into a single optical waveguide, such as a large core plastic fiber, that transmits the light to a location that is remote from the source/sources. In yet another approach, the single fiber may be replaced by a bundle of individual optical fibers.

The present methods are very inefficient with approximately 70% loss of light generated in some cases. In multiple fiber systems, these losses may be due to the dark interstitial spaces between fibers in a bundle and the inefficiencies of directing the light into the fiber bundle. In single fiber systems, a single fiber having a large enough diameter to capture the amount of light needed for bright lighting applications becomes too thick and loses the flexibility to be routed and bent in small radii.

Some light generating systems have used lasers as sources, to take advantage of their coherent light output. Laser sources typically produce a single output color, however, whereas an illumination system typically requires a more broadband white light source. Furthermore, since laser diodes commonly produce light having an asymmetrical beam shape, the extensive use of optical beam shaping elements is required to achieve efficient coupling into the optical fibers. Additionally, some laser diodes are expensive to utilize since they require stringent temperature control (e.g., the need for using thermoelectric coolers, and the like) due to the heat they generate in operation.

There remains a continuing need for a light source that generates light efficiently and inexpensively, and that can be used for remote illumination.

### SUMMARY OF THE INVENTION

One particular embodiment of the invention is directed to a light source that comprises light emitting diode (LED) dies capable of emitting LED light and optical couplers for coupling light from respective LED dies. Phosphor patches are disposed between the LED dies and the optical couplers to convert at least a portion of the LED light propagating to the optical couplers from respective LED dies. An intermediate layer is disposed between the LED dies and the phosphor patches. The intermediate layer transmits the LED light and reflects light converted in the phosphor patches. The intermediate layer has a first side facing the LED dies and a second side facing the couplers. The phosphor patches are disposed on the second side of the intermediate layer. The LED light may be blue or ultraviolet.

Another embodiment of the invention is directed to a light source that comprises two or more light emitting diode (LED) dies to produce LED light and two or more respective couplers for coupling light from the LED dies. An intermediate layer is disposed between the LED dies and the couplers. The intermediate layer is substantially transparent to the LED light. A phosphor layer is disposed on the intermediate layer, between the intermediate layer and the couplers, for converting at least a portion of the LED light to light at a converted wavelength.

Another embodiment of the invention is directed to a light source that comprises a plurality of light emitting diode (LED) dies capable of emitting LED light and a first layer disposed over the LED dies. The first layer is substantially transparent to the LED light. The LED light propagates through the first layer from a first side of the first layer to a second side of the first layer. A phosphor layer is disposed on the second side of the first layer.

Another embodiment of the invention is directed to a method of assembling a light source. The method comprises providing a plurality of light emitting diode (LED) dies capable of emitting LED light. A layer of phosphor is disposed on a first layer, where the first layer is substantially transparent to the LED light. The first layer and the layer of phosphor are positioned over the LED dies so that LED light passes through the first layer from the LED dies to the layer of phosphor.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of an illumination system that uses multiple light sources, according to principles of the present invention;

FIG. 2 schematically illustrates a cross-section through the assembled illumination system shown in FIG. 1, according to principles of the present invention;

FIG. 3 schematically illustrates a cross-section through an embodiment of another illumination system according to principles of the present invention;

FIGS. 4A and 4B schematically illustrate the wavelength conversion of light in reflector/phosphor stacks according to principles of the present invention;

FIG. 5 presents a graph showing the spectra of LED and wavelength converted light both with and without the use of a reflector for the wavelength converted light;

FIG. 6 presents a schematic exploded view of a light source that uses multiple LEDs, according to principles of the present invention;

FIGS. 7A and 7B present expanded schematic views of an embodiment of a coupler sheet used in the light source of FIG. 6, according to principles of the present invention;

FIG. 8 shows an expanded schematic view of an embodiment of an intermediate layer used in the light source of FIG. 6, according to principles of the present invention;

FIG. 9 schematically illustrates an embodiment of a partially assembled light source according to principles of the present invention; and

FIG. 10 schematically illustrates an embodiment of an assembled light source according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to illumination systems based on the use of one or more light emitting diodes (LEDs), and methods for manufacturing such systems.

LEDs with higher output power are becoming more readily available, which opens up new applications for LED illumination with white light. Some applications that may be addressed with high power LEDs include their use as light sources in projection and display systems, as illumination sources in machine vision systems and camera/video applications, and even in distance illumination systems such as car headlights. Different approaches may be used to generate white light using LEDs. One approach is to employ a combination of LEDs emitting light at different wavelengths. Another approach is to use LEDs that generate light at a short wavelength, for example in the blue or near ultraviolet (UV) portions of the spectrum, and to convert the short wavelength light to other wavelengths in the visible spectrum. The resultant light covers a substantial portion of the visible spectrum, and is referred to here as broadband light. LEDs that emit light in the blue or UV portions of the spectrum may be based on gallium nitride, silicon carbide, or other semiconductor materials having a band gap suitable for the generation of blue or UV light.

White light is light that stimulates the red, green, and blue sensors in the human eye to yield an appearance that an ordinary observer would consider “white”. Such white light may be biased to the red (commonly referred to as warm white light) or to the blue (commonly referred to as cool white light). Such light can have a color rendition index of up to 100.

Materials that are used to convert light at a shorter wavelength to light at longer wavelengths are referred to herein as phosphors. The phosphor may use different mechanisms to generate the longer wavelength light, for example, fluorescence or phosphorescence. The phosphor may be inorganic, organic, or a combination of both. Examples of inorganic phosphors garnets, silicates and other ceramics. A specific example of a garnets phosphor is gadolinium doped, cerium activated yttrium aluminum garnet (Ce:YAG). Other fluorescent species may be used, for example, rare earth dopants such as samarium, praseodymium or the like. Examples of organic phosphors include organic fluorescent materials, such as organic dyes, pigments and the like.

The phosphor materials typically have excitation wavelengths in the range from about 300 nm-about 450 nm and emission wavelengths in the visible wavelength range. In the case of phosphor materials having a narrow emission wavelength range, a mixture of phosphor materials may be used formulated to achieve a desired color balance, as perceived by the viewer, for example a mixture of red-, green- and blue-emitting phosphors. Phosphor materials having broader emission bands are useful for phosphor mixtures having higher color rendition indices. Desirably, phosphors should have fast radiative decay rates.

A phosphor blend may comprise phosphor particles, for example, having a size ranging from about 1 micron to about 25 microns, dispersed in a binder such as epoxy, adhesive, or a polymeric matrix, which can then be applied to a desired surface. Phosphors that convert light in the range of about 300 mn to about 450 nm to longer wavelengths are available from, for example, Phosphor Technology Ltd., Essex, England. Materials with high stability under 300-470 nm radiation are preferred, particularly inorganic phosphors.

It will be appreciated that phosphors may be used to convert blue light into green, yellow and/or red light, so a blue LED can be used to generate broadband light, or “white” light, by adding the blue light to the light generated in the phosphor. Also, a UV LED can generate light that a phosphor converts to blue, green, yellow and/or red light, so a UV LED can be used to generate broadband light.

LEDs typically emit light over a wide angle, so one of the challenges for the optical designer is to ensure that the light emitted from the LED is collected and converted to longer wavelengths as efficiently as possible. In some applications, the broadband light is directed to a light guide, such as an optical fiber, so that the broadband light may be used for remote illumination. Another challenge for the designer is to ensure that the resulting broadband light is efficiently directed to the target, for example the input surface of an optical fiber.

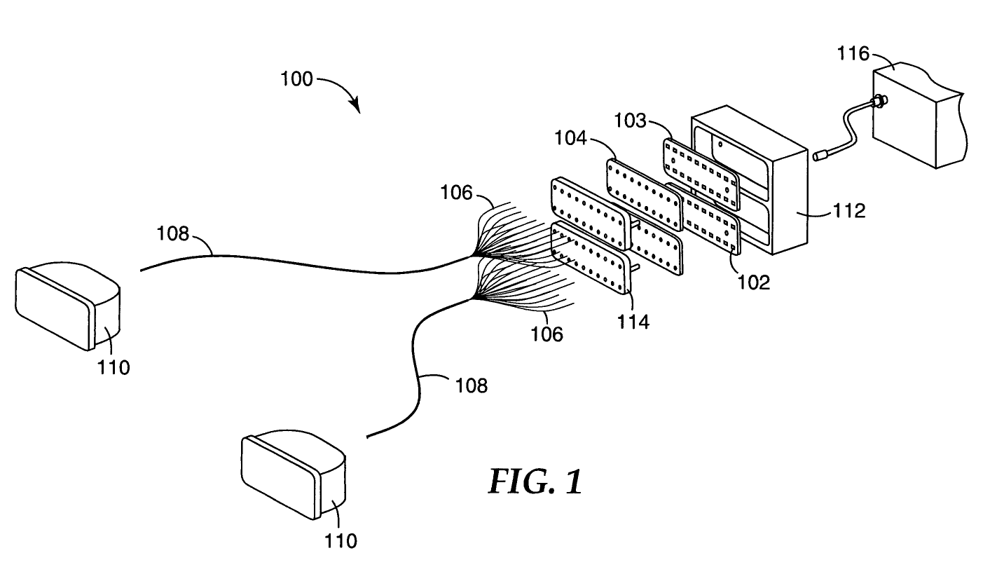

An example of a light illumination system 100 that uses a light source with multiple LEDs is schematically illustrated in the exploded view shown in FIG. 1. The system 100 includes a number of LEDs 102 in an array that are optically coupled via respective reflective couplers 104 in a matching array to respective optical fibers 106. The fibers 106 may be collected together into one or more bundles 108 that carry light to one or more illumination units 110. The fibers 106 may be multimode optical fibers. The LEDs 102, and the reflective couplers 104 may be housed in a housing 112 and the fibers 106 may be held in a spatial array close to their respective couplers 104 and LEDs 102 using a fiber mounting plate 114. The system 100 may include a power supply 116 coupled to provide electrical power to the LEDs 102.

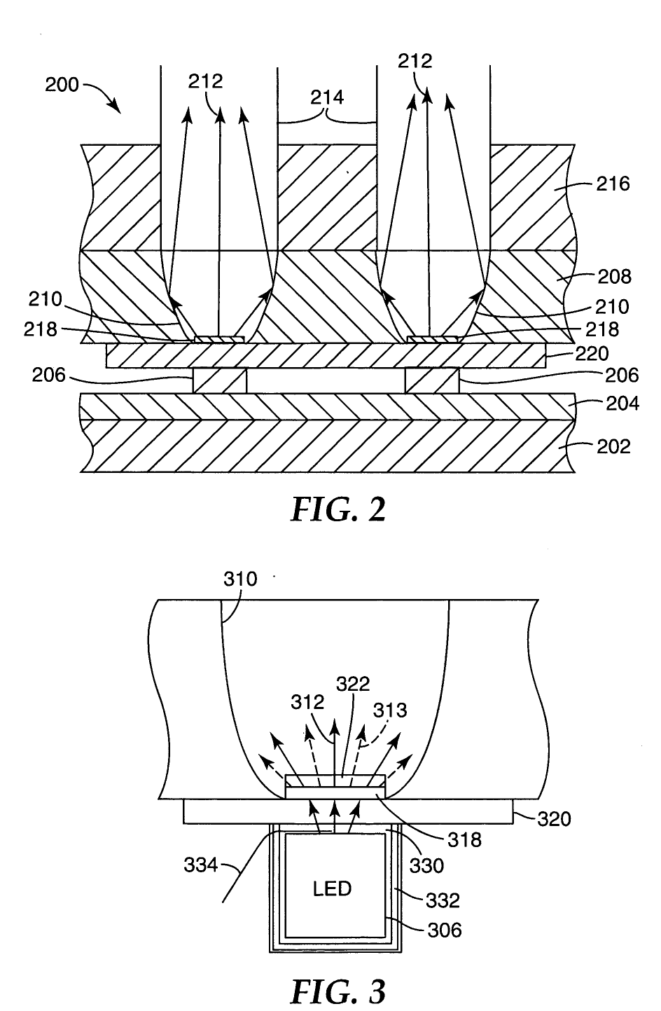

A cross-section through an embodiment of a section of a multiple LED light source 200 is schematically presented in FIG. 2. The light source 200 may include a base 202 that may be used as a heatsink. A thermally conductive layer 204 may be used to provide thermal coupling between an array of LEDs 206 and the base 202. The LEDs 206 may be provided as chips, also referred to as dies. A coupler sheet 208 contains an array of couplers 210, for example reflective couplers, that couple light 212 from the LEDs 206 to an array of respective optical fibers 214. The LEDs 206 are optically coupled to respective fibers 214 via respective couplers 210.

The fibers 214 may be held in position relative to the array of reflective couplers 210 by a fiber plate 216. The output ends of the fibers 214 may be gathered and used as a light source for illumination. The coupler sheet 208 may be molded with apertures therethrough to form reflective couplers 210. The reflecting surfaces of the reflective couplers may be formed using different approaches, e.g. by metallization or by dielectric thin film coatings. The use of reflective couplers for coupling light from LEDs to optical fibers is discussed in greater detail in “REFLECTIVE LIGHT COUPLER”, Attorney Docket No. 59121US002, “ILLUMINATION SYSTEM USING A PLURALITY OF LIGHT SOURCES”, Attorney Docket No. 58130US004 and U.S. Provisional Patent Application No. 60/430,230, filed on Dec. 2, 2002, all of which are incorporated herein by reference.

The color of at least some of the light 212 generated by the LEDS 206 may be converted to one or more different colors, so as to cover a broader range of the visible spectrum. For example, where the LEDs 206 generate blue or UV light, a phosphor may be used to generate light in other color bands in the visible region of the spectrum, for example green, yellow and/or red. The phosphor may be included on top of the LEDs 206, may be provided at the entrance to the fibers, or may be provided elsewhere. In the illustrated embodiment, patches 218 of phosphor are disposed on an intermediate layer 220 that lies between the LEDs 206 and the coupler sheet 208. In some embodiments, the intermediate layer 220 may butt up against the input side of the coupler sheet 208 so that the phosphor patches 218 fit into the apertures of the reflective couplers 210.

The reflective couplers 210 may be air-filled or may contain a transparent material having a higher refractive index than air, such as optical epoxy. Use of a transparent material may reduce the Fresnel reflections at the surface of the phosphor patch 218 and, hence, permit more wavelength converted light to couple from the phosphor patches 218 to the fibers 214.

An expanded view of an LED coupling to the phosphor patch is schematically presented in FIG. 3. The LED 306 may be a die that is embedded within an encapsulant 330, for example a polymer coating. A reflector 332 may be disposed around at least part of the LED 306 to reflect light towards the reflective coupler 310. The reflector 332 may be, for example, a metallic reflector, a multilayer dielectric reflector or a multilayer optical polymer film reflector. An electrical conductor 334 may be contacted to the top of the LED die 306 for applying a current to the LED die 306. Typically, the current path passes through the bottom surface of the LED die to another conductor.

Light 312 from the LED die 306 passes through the intermediate layer 320 to the phosphor patch 318. The phosphor patch 318 converts some of the incident light 312 to light 313 at a longer wavelength than the incident light 312. In this, and the following figures, light 312 emitted directly by the LED is shown using solid lines, and wavelength converted light 313 that is produced within the phosphor 318 from the incident light 312 is shown using dashed lines.

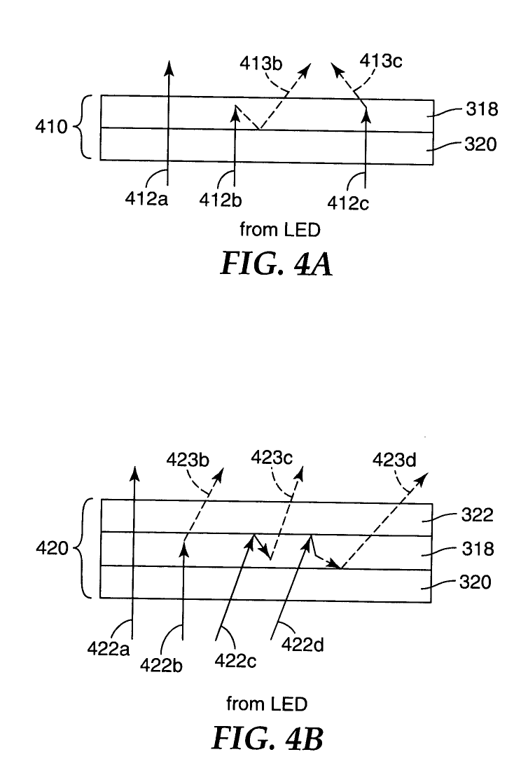

One or more different reflective layers may be used to enhance the efficiency wavelength conversion by the phosphor patch 318. For example, the intermediate layer 320 may transmit the light 312 emitted by the LED die 306, but may also reflect the light 313 at longer wavelengths that is generated within the phosphor patch 318. Such an intermediate layer is referred to herein as a transflective intermediate layer 320. The use of a transflective intermediate layer 320 is described with reference to FIG. 4A, which shows a phosphor/reflector stack 410 comprising a layer of phosphor 318 over the transflective intermediate layer 320. The transflective intermediate layer 320 transmits the light emitted by the LED, but reflects light at longer wavelengths. Some of the light 412a from the LED may be transmitted through the phosphor layer 318 without being wavelength converted. Some of the light 412b from the LED undergoes wavelength conversion within the phosphor layer 318 to produce wavelength converted light 413b that is transmitted out of the phosphor layer 318. Some of the light 412c from the LED undergoes wavelength conversion within the phosphor layer 318 to produce wavelength converted light 413c that initially propagates in a direction generally back towards the LED. Since the transflective intermediate layer 320 reflects the wavelength converted light 413c, the wavelength converted light 413c is reflected in the forward direction. Thus, a transflective intermediate layer 320 that reflects the wavelength converted light may be used to increase the efficiency of producing wavelength converted light that propagates in the desired, forward direction.

The transflective intermediate layer 320 may use different types of reflectors to reflect the wavelength converted light. For example, the layer 320 may comprise a transparent substrate and a dielectric reflector stack. In another example, the layer 320 may comprise a multiple-layer optical polymer film (MOF) reflector formed from a stack of polymer layers having alternating values of refractive index. Such a reflector is further described in, for example, U.S. Pat. Nos. 5,882,774 and 5,808,794; in U.S. Provisional Patent Applications, Nos. 60/443,235, 60/443,274 and 60/443,232, each of which was filed on Jan. 27, 2003; and in the following applications filed on even date herewith—“Phosphor Based Light Sources Having a Polymeric Long Pass Reflector” having attorney docket no. 58389US004 and “Phosphor Based Light Sources Having a Non-Planar Long Pass Reflector” having attorney docket no. 59416US002. All the references listed in this paragraph are incorporated herein by reference.

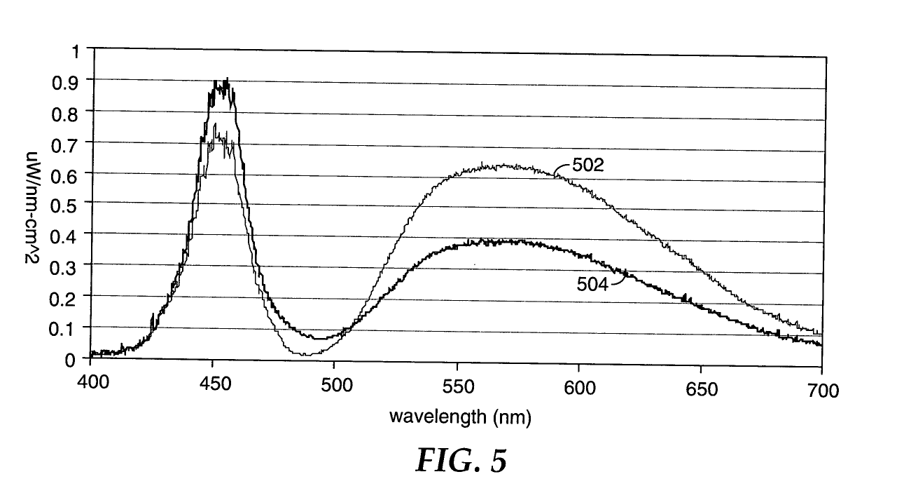

FIG. 5 shows a graph that compares the spectrum of light produced by an LED illuminating a phosphor with (curve 502) a MOF reflector as the transflective intermediate layer and the same phosphor with a non-reflecting intermediate layer (curve 504). The LED emitted blue light, peaking at about 450 nm. The phosphor was Type A phosphor material available from PhosphorTech Corp., Lithia Springs, Ga. and produced broadband light over the range of about 525 nm to about 625 nm. The use of a MOF transflective intermediate layer significantly increases the amount of converted light having a wavelength greater than 500 nm.

A second reflector layer 322 may optionally be disposed over the phosphor patch 318 to further increase the wavelength conversion efficiency. The second reflector 322 layer generally reflects light at the LED wavelength and transmits light at the converted wavelength, and is now described with reference to FIG. 4B. A reflector/phosphor stack 420 comprises the phosphor layer 318 disposed between the transflective intermediate layer 320 and the second reflector 322. Some of the light 422a incident from the LED may be transmitted through the reflector/phosphor stack 420. Other light 422b from the LED is converted within the phosphor layer 318 to converted light 423b that passes through the second reflector 322 in the forward direction. Some light 422c from the LED passes through the phosphor layer 318 and is reflected back to the phosphor layer 318 by the second reflector layer 322. The reflected light 422c is converted to converted light 423c that passes through the second reflector layer 322 in the forward direction.

Some light makes use of both reflecting layers 320 and 322. For example, light 422d from the LED passes through the transflective intermediate layer 320 and the phosphor layer 318, to be reflected back into the phosphor layer 318 by the second reflector 322. The reflected light 422d generates converted light 423d in the phosphor layer 318. The converted light reflects off the transflective intermediate layer 320 and is directed out through the second reflector 322 in the forward direction. Thus, wavelength selective reflectors above and below the phosphor layer 318 may be used to increase the efficiency with which broadband light is produced from the LEDs.

Different characteristics of the stacks 410 and 420, for example reflectivity of the intermediate layer and of the second reflector, and the phosphor density and thickness, may be adjusted to produce a desired balance in the color of the light transmitted in the forward direction. For example, if blue light were incident on the stack 410, the amount of blue light passing directly through the stack is dependent, in part, on how much blue light is converted to longer wavelengths in the phosphor layer 318. This, in turn, is dependent on phosphor density and the thickness of the phosphor layer 318. Also, the amount of converted light that is transmitted in the forward direction is dependent on how much converted light is generated in the phosphor layer 318 and how much converted light is reflected by the transflective intermediate layer 320. Thus, adjustment of the amount of phosphor present in the stack and/or the reflectivity of the transflective intermediate layer permits the designer to adjust the relative amounts of converted light and blue light and thus achieve a desired color balance. Use of the second reflector layer 322 provides an additional parameter that may be selected to adjust how much blue light is transmitted through the stack 420 and how much light is produced by phosphor conversion.

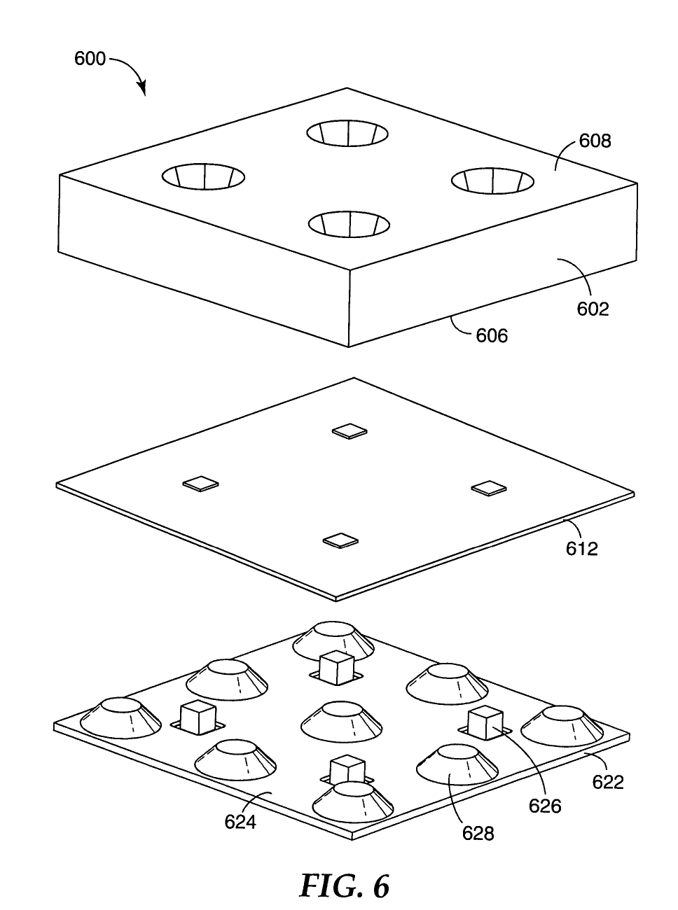

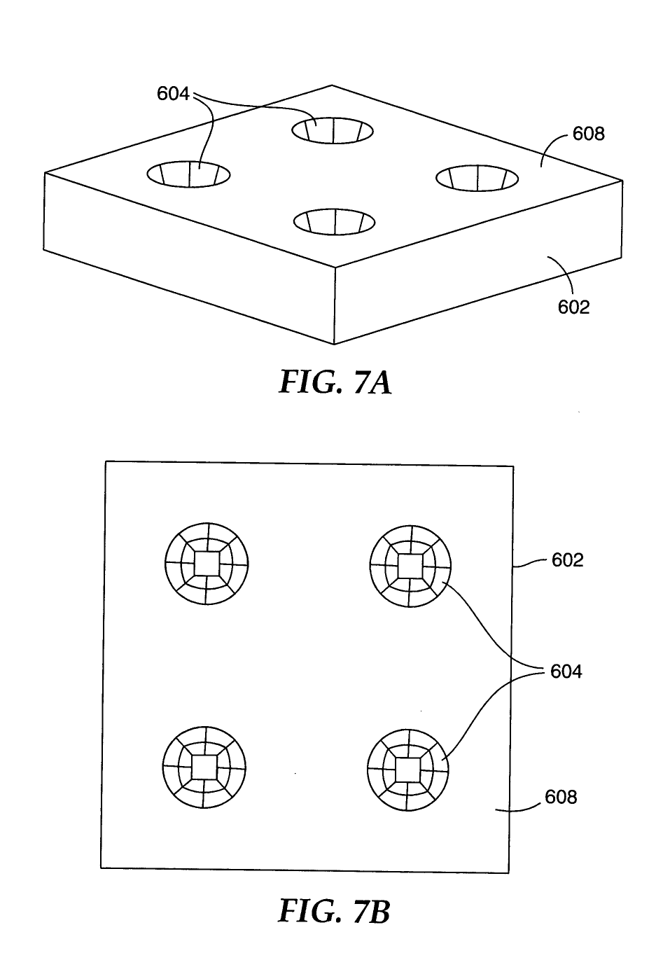

The present invention is directed to a light source that uses multiple LEDs. The LEDs may be provided in a regular array. A 2×2 array is described in the following discussion, but it will be appreciated that the invention is intended to cover other numbers of LEDs and other sizes of arrays. FIG. 6 presents a schematic illustration showing an exploded view of a multiple LED light source 600. A reflective coupler sheet 602, shown in greater detail in FIGS. 7A and 7B, includes an array of reflective couplers 604 formed in apertures through the sheet 602. The inputs to the reflective couplers 604, on the lower surface 606, may be shaped to match the geometry of the LEDs and the phosphor patches, while the outputs from the reflective couplers 604, on the upper surface 608, may be shaped to match the inputs to the optical fibers. The reflective coupler sheet 602 may be molded as a single piece with the apertures in which the reflective couplers are formed. The sidewalls of the apertures may then be provided with a reflective coating, for example an aluminum coating, to form the reflective couplers 604.

A middle component, comprising an intermediate layer 612, is shown in greater detail in FIG. 8. The intermediate layer 612 is provided with a number of phosphor patches 614 on one side. The phosphor patches 614 may be arranged on the intermediate layer 612 with a desired shape and thickness, and may form a pattern similar to the pattern of reflective couplers 604 on the reflective coupler sheet. The intermediate layer 612 may or may not be transflective.

The phosphor patches 614 may be constituted in different ways. For example, a patch 614 may contain phosphor particles disposed within a binder that is cured or set on the surface of the intermediate layer 612. The phosphor particles may be formed from any suitable type of phosphor material, for example inorganic or organic phosphors as discussed above. Suitable binder materials may include transparent optical adhesives, such as NOA81 (Norland Products Inc., New Jersey).

The phosphor patches 614 may be disposed on the intermediate layer 612 using different methods. For example, the phosphor patches 614 may be printed on the intermediate layer 612 using a screen printing method, such as a silk screen method. Other approaches that may be used for disposing the phosphor patches 614 on the intermediate layer 612 include lithographic processes, molding, spraying and the like. One example of a lithographic process is a photolithographic process. Once example of a molding process is to have a platen that has recesses corresponding to the positions of the patches. The recesses are filled with the phosphor-containing material and the platen then pressed against the surface of the intermediate layer. An example of a spraying process is inkjet printing. The phosphor patches 614 may be cured on the intermediate layer 612, if needed, after printing.

An LED subassembly 622 may include a substrate 624 formed of using a flexible circuit to carry electrical conductors that provide the current to and from the LEDs 626 that are mounted on its surface. For example, the flexible circuit may be as is further described in related application “ILLUMINATION ASSEMBLY” having Attorney Docket No. 59333US002 and filed on even date herewith or in U.S. Pat. No. 5,227,008, incorporated herein by reference.

The LEDs 626 may be provides as naked dies or the dies may be encapsulated. The LED subassembly 622 may also have stand-offs 628 to provide space for the LEDs 626 between the substrate 624 and the intermediate layer 612. The stand-offs are at least as tall as the LEDs 626, and may be taller than the LEDs 626. In the case where the LEDs 626 have a top wire bond, the stand-offs may also provide room for the wire bonds at the top of the LEDs 626. The wire bonds may be connected to conductors on the upper surface of the substrate 624. Different shapes and configurations of stand-offs may be used. For example, the stand-offs 628 may be tapered, as illustrated, or may have parallel sides. The stand-offs 628 may have a circular cross-section or may take on different shapes. Also, the stand-offs 628 may be located on the substrate 624 in a pattern different from that shown. The standoffs may alternatively be located on the film 612, on the side opposite the phosphor patches 614. The standoffs may engage recesses on the opposing surface so as to assist in lateral alignment of the LEDs to the phosphor patches and/or the couplers.

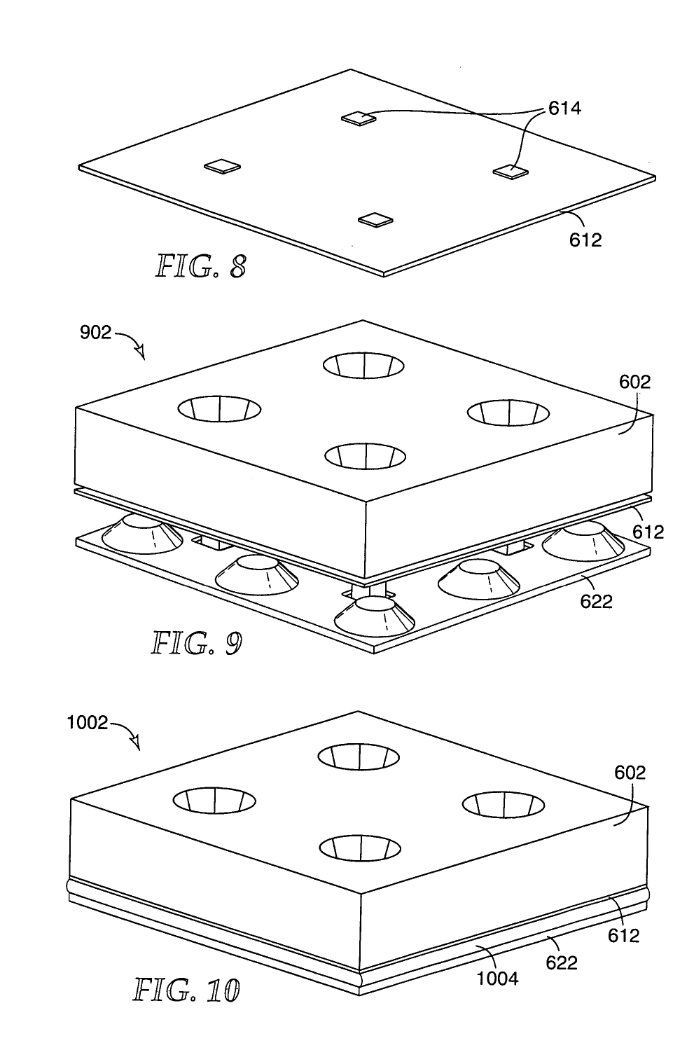

A method of manufacturing a multiple LED light source is as follows. Once the reflective coupler sheet 602 has been completed and the intermediate layer 612 has been provided with the phosphor patches 614, the sheet 602 and the intermediate layer 612 are bonded together. The phosphor patches 614 are registered to the apertures of respective reflective couplers 604, and may actually extend into the apertures of the reflective couplers 604, for example as shown in FIGS. 2 and 3. The intermediate layer 612 and the coupler sheet 602 may be bonded using any suitable technique. For example, the intermediate layer 612 and the coupler sheet 602 may be bonded together using an epoxy. The bonded subassembly 902, comprising the reflective coupler sheet 602 and the intermediate layer 612, illustrated in FIG. 9, may be comparatively rigid, which makes handling of the subassembly 902 in subsequent assembly steps easier.

The subassembly 902 may then be bonded to the LED subassembly 622. This can be performed using a variety of different methods. For example, regions of epoxy may be applied to the stand-offs 628 and the subassembly mounted to the epoxy on the stand-offs 628. In another approach, excess encapsulant, such as an epoxy, may also be added to the top of the LEDs 626.

Different techniques may be used to achieve lateral alignment of the LEDs 626 to the phosphor patches 614 and the reflective couplers 604. One approach is to illuminate the LEDs 626 and to monitor the light transmitted through the coupler sheet 602. A preferred alignment between the LEDs 626 and the subassembly is achieved when the amount of light transmitted through the coupler sheet 602 is maximized.

A seal 1004, for example a bead of epoxy, may be provided around the perimeter of the assembled light source 1002, as is schematically illustrated in FIG. 10, to prevent dust, dirt and the like from entering into the space between layers 612 and 622. The seal 1004 may also completely fill the space between the layers 612 and 622.

The assembled light source 1002 produces directed white light using an array of blue or UV LEDs. Optical fibers may be coupled to the respective openings on the reflective coupler sheet 602, so that the light may be guided to a desired location for illumination.

The light source 1002 allows cost effective assembly of an efficient, directed white or broadband light source from short wavelength LEDs. The use of an intermediate layer in a large sheet to cover multiple LEDs avoids the complex process of printing the phosphor material directly on the LEDs themselves, and the need to cut the sheet up into small regions that fit the phosphor patches. Furthermore, the intermediate layer may be provided with reflective properties for increasing the wavelength conversion efficiency. Also, the cost of the excess material of the intermediate layer, between adjacent LEDs, is low and so the addition of the intermediate layer does not substantially increase the cost of the materials used in the light source. Thus, the intermediate layer maintains low cost and simplifies the assembly of the light source. Furthermore, the steps of bonding and alignment lead to an assembly that is rigid and encapsulated, without significant stresses on areas of concern, such as the wire bonds to the top of the LEDs.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A light source, comprising:
light emitting diode (LED) dies capable of emitting LED light;
optical couplers for coupling light from respective LED dies;
phosphor patches disposed between the LED dies and the optical couplers to convert at least a portion of the LED light propagating to the optical couplers from respective LED dies; and
an intermediate layer disposed between the LED dies and the phosphor patches, the intermediate layer transmitting the LED light and reflecting light converted in the phosphor patches, the intermediate layer having a first side facing the LED dies and a second side facing the couplers, the phosphor patches being disposed on the second side of the intermediate layer.

2. A light source as recited in claim 1, wherein the LED dies are arranged in a regular array.

3. Al light source as recited in claim 1, wherein the LED dies are encapsulated.

4. A light source as recited in claim 1, wherein the LED dies are disposed on a substrate.

5. A light source as recited in claim 4, further comprising at least one stand-off disposed between the intermediate layer and the substrate.

6. A light source as recited in claim 1, wherein the couplers are reflective couplers formed by apertures through a coupler sheet, the apertures having reflective side walls.

7. A light source as recited in claim 6, wherein the phosphor patches register with respective apertures.

8. A light source as recited in claim 6, wherein the phosphor patches extend into the apertures from the intermediate layer.

9. A light source as recited in claim 1, further comprising a reflective layer disposed to reflect LED light that has passed through the phosphor layer back to the phosphor layer.

10. A light source as recited in claim 1, further comprising a set of optical fibers disposed to receive light from respective couplers.

11. A light source as recited in claim 1, further comprising a power supply connected to provide electrical current to the plurality of LED dies.

12. A light source, comprising:
two or more light emitting diode (LED) dies to produce LED light;
two or more respective couplers for coupling light from the LED dies;
an intermediate layer disposed between the LED dies and the couplers, the intermediate layer being substantially transparent to the LED light; and
a phosphor layer disposed on the intermediate layer, between the intermediate layer and the couplers, for converting at least a portion of the LED light to light at a converted wavelength.

13. A light source as recited in claim 12, wherein the LED dies are arranged in a regular array.

14. A light source as recited in claim 12, wherein the LED dies are encapsulated.

15. A light source as recited in claim 12, wherein the LED dies are disposed on a substrate.

16. A light source as recited in claim 15, further comprising at least one stand-off disposed between the intermediate layer and the substrate.

17. A light source as recited in claim 12, wherein the couplers are reflective couplers formed by apertures through an aperture sheet, the apertures having reflective side walls.

18. A light source as recited in claim 12, wherein the phosphor layer is provided as patches of phosphor-containing material distributed on the intermediate layer, the patches being located at positions corresponding to areas of the intermediate layer illuminated by the LED dies.

19. A light source as recited in claim 18, wherein the couplers are formed in apertures through an aperture sheet, the patches registering with the apertures.

20. A light source as recited in claim 19, wherein the patches of phosphor-containing material extend into the apertures from the intermediate layer.

21. A light source as recited in claim 19, wherein the intermediate layer reflects light at the converted wavelength.

22. A light source as recited in claim 19, further comprising a reflective layer disposed to reflect LED light that has passed through the phosphor layer back to the phosphor layer.

23. A light source as recited in claim 12, wherein the intermediate layer reflects the converted light.

24. A light source as recited in claim 12, further comprising a set of optical fibers disposed to receive light from respective optical couplers.

25. A light source as recited in claim 12, further comprising a power supply connected to provide electrical current to the LED dies.

26. A light source, comprising:
a plurality of light emitting diode (LED) dies capable of emitting LED light;
a first layer disposed over the LED dies, the first layer being substantially transparent to the LED light, the LED light propagating through the first layer from a first side of the first layer to a second side of the first layer; and
a phosphor layer disposed on the second side of the first layer.

27. A light source as recited in claim 26, wherein the LED dies are arranged in a regular array.

28. A light source as recited in claim 26, wherein the phosphor layer is provided as patches of phosphor-containing material distributed on the first layer, the patches being located at positions corresponding to areas of the first layer illuminated by the LED dies.

29. A light source as recited in claim 26, wherein the first layer reflects light converted by the phosphor layer to a longer wavelength than the wavelength of the LED light.

30. A light source as recited in claim 26, further comprising a reflective layer disposed to reflect LED light that has passed through the phosphor layer back to the phosphor layer.

31. A light source as recited in claim 26, wherein the LED dies are arranged on a substrate.

32. A light source as recited in claim 31, further comprising at least one stand-off between the substrate and the first layer.

33. A method of assembling a light source, comprising:
providing a plurality of light emitting diode (LED) dies capable of emitting LED light;
disposing a layer of phosphor on a first layer, the first layer being substantially transparent to the LED light;
positioning the first layer and the layer of phosphor over the LED dies so that LED light passes through the first layer from the LED dies to the layer of phosphor.

34. A method as recited in claim 33, wherein disposing the layer of phosphor on the first layer comprises disposing the layer of phosphor as patches on a surface of the first layer, the positions of the patches on the first layer corresponding to areas where light passes from the LED dies through the first layer.

35. A method as recited in claim 33, wherein providing the plurality of LED dies comprises arranging the LED dies in a regular array pattern.

36. A method as recited in claim 33, wherein providing the plurality of LED dies comprises providing the plurality of LED dies on an LED subassembly, and further comprising attaching the LED subassembly to the first layer.

37. A method as recited in claim 36, wherein one of the LED subassembly and the first layer comprises a plurality of stand-offs, and attaching the LED subassembly to the first layer comprises attaching the stand-offs to the other of the LED subassembly and the first layer.

38. A method as recited in claim 33, wherein providing the intermediate layer comprises providing an intermediate layer that transmits the LED light and that reflects light that is wavelength converted in the phosphor layer.

39. A method as recited in claim 33, further comprising providing a reflector layer to reflect LED light that has passed through the phosphor layer back to the phosphor layer.
